(19) United States
(12) Patent Application Publication
(10) Pub. No.: US 2023/0101914 A1
(43) Pub. Date: Mar. 30, 2023

(54) COMMUNICATION TERMINAL, MANAGEMENT SYSTEM, AND COMMUNICATION CONTROL METHOD

(71) Applicant: KDDI CORPORATION, Tokyo (JP)

(72) Inventors: Hiroshi SUGITA, Tokyo (JP); Kazuma HARADA, Tokyo (JP)

(73) Assignee: KDDI CORPORATION, Tokyo (JP)

(21) Appl. No.: 17/954,964

(22) Filed: Sep. 28, 2022

(30) Foreign Application Priority Data
Sep. 30, 2021 (JP) 2021-160428

(51) Int. Cl. H04L 51/222; H04W 64/00; H04L 51/214; H04L 51/58

(52) U.S. Cl. CPC H04L 51/222; H04W 64/003; H04L 51/214; H04L 51/58

(57) ABSTRACT

A communication terminal includes: a flying object information acquiring unit configured to acquire flying object information including manager identification information of managers of flying objects and information about flight locations from the flying objects; a display control unit configured to cause a display unit to display the flight locations of the flying objects on the basis of the acquired flying object information; a selection accepting unit configured to accept selection of a target flying object from among one or more flying objects of which the flight locations are displayed in the display unit; and a communication control unit configured to transmit the manager identification information of the manager of the selected target flying object and a message for the manager or a chatting start request for chatting with the manager to a management device.

### CROSS REFERENCE TO RELATED APPLICATION

Priority is claimed on Japanese Patent Application No. 2021-160428, filed Sep. 30, 2021, the content of which is incorporated herein by reference.

### BACKGROUND OF THE INVENTION

### Field of the Invention

The present invention relates to a communication terminal, a management system, and a communication control method.

### Description of Related Art

In recent years, drones that are unmanned flying objects have been widely used. A user managing a flying object or a monitoring staff monitoring a flying object can check a location of the flying object during flight, for example, on a screen of his or her own terminal. This screen can display a plurality of flying objects and, for example, enables a user to check the presence of other flying objects in the vicinity of a flying object managed by the user (see Japanese Unexamined Patent Application, First Publication No. 2021-119714).

However, there are cases in which another flying object and the flying object of the user come close to each other during flight and cases in which some flying objects fly near a flight prohibition area. In such cases, in order to avoid collision of the flying object or avoid flight in a flight prohibition area, a user or a monitoring staff of the flying object needs to contact a manager of a target flying object. However, in a conventional system, in order to check a telephone number of a corresponding manager and make a phone call to the manager, the user or the monitoring staff is forced to perform a complicated operation.

### SUMMARY OF THE INVENTION

The present invention is in view of such points, and an object thereof is to enable a manager of a flying object to make contact in an easy manner.

According to a first aspect of the present invention, there is provided a communication terminal including: a flying object information acquiring unit configured to acquire flying object information including manager identification information of managers of flying objects and information about flight locations from the flying objects; a display control unit configured to cause a display unit to display the flight locations of the flying objects on the basis of the acquired flying object information; a selection accepting unit configured to accept selection of a target flying object from among one or more flying objects of which the flight locations are displayed in the display unit; and a communication control unit configured to transmit the manager identification information of the manager of the selected target flying object and a message for the manager or a chat start request for chatting with the manager to a management device.

In addition, the display control unit may be configured to display an input screen for inputting a message for the manager of the selected target flying object, and the communication control unit may be configured to transmit the manager identification information of the manager of the target flying object and a message input to the input screen to the management device.

Furthermore, the information about the flight locations may be configured to include path information representing flight paths of the flying objects, and the display control unit may be configured to cause the display unit to display the flight paths represented by the acquired path information.

In addition, the information about the flight locations may be configured to include scheduled flight information representing scheduled flight locations or scheduled flight paths of the flying objects, and the display control unit may be configured to cause the display unit to display the scheduled flight locations or the scheduled flight paths represented by the acquired scheduled flight information.

Furthermore, the communication control unit may be configured to transmit transmission source information including user identification information used for identifying a user of its own terminal together with the manager identification information.

In addition, the flying object information acquiring unit may be configured to receive the flying object information directly from the flying objects or receives the flying object information from the flying objects through a mobile communication network.

Furthermore, the flying object information acquiring unit may be configured to acquire the flying object information of a managed flying object managed by a user of its own terminal among the flying objects, and the display control unit may be configured to cause the display unit to display a flight location of the managed flying object on the basis of the acquired flying object information of the managed flying object.

In addition, the display control unit may be configured to cause the display unit to simultaneously display flight locations of the managed flying object and other flying objects, and the selection accepting unit may be configured to accept selection of the target flying object among flying objects having a predetermined flight location relation with the managed flying object out of the other flying objects.

Furthermore, the display control unit may be configured to cause the display unit to display the flight locations of the flying objects and information representing a predetermined area, and the selection accepting unit may be configured to accept selection of the target flying object among flying objects located in the predetermined area out of the flying objects.

According to a second aspect of the present invention, there is provided a management system including: a management device of flying objects; and a communication terminal configured to communicate with the management device, in which the communication terminal includes: a flying object information acquiring unit configured to acquire flying object information including manager identification information of managers of flying objects and information about flight locations from the flying objects; a display control unit configured to cause a display unit to display the flight locations of the flying objects on the basis of the acquired flying object information; a selection accepting unit configured to accept selection of a target flying object from among one or more flying objects of which the flight locations are displayed in the display unit; and a communication control unit configured to transmit the manager identification information of the manager of the selected target flying object, transmission source information including user identification information used for identifying a user of its own terminal, and a message for the manager or a chat start request for chatting with the manager to a management device, and the management device includes: a terminal identifying unit configured to identify a terminal of the manager on the basis of the manager identification information received from the communication terminal; and a management-side communication control unit configured to transmit the message received from the communication terminal or identification information of a chat room used for chatting with the user of the communication terminal to the identified terminal.

According to a third aspect of the present invention, there is provided a communication control method causing a computer to perform: acquiring flying object information including manager identification information of managers of flying objects and information about flight locations from the flying objects; causing a display unit to display the flight locations of the flying objects on the basis of the acquired flying object information; accepting selection of a target flying object from among one or more flying objects of which the flight locations are displayed in the display unit; and transmitting the manager identification information of the manager of the selected target flying object and a message for the manager or a chat start request for chatting with the manager to a management device.

According to the present invention, there is an effect of being able to easily contact a manager of a flying object.

### BRIEF DESCRIPTION OF THE DRAWINGS

FIG. 1 is a schematic view illustrating a management system according to one embodiment of the present invention.

FIG. 2 is a block diagram illustrating a communication terminal according to one embodiment.

FIG. 3 is a diagram illustrating a display example of a display unit of the communication terminal according to one embodiment.

FIG. 4 is a diagram illustrating an input screen of the communication terminal according to one embodiment.

FIG. 5 is a diagram illustrating a modified example of the display example of the display unit of the communication terminal according to one embodiment.

FIG. 6 is a block diagram illustrating a management device according to one embodiment.

FIG. 7 is a flowchart representing one example of a process performed by the communication terminal according to one embodiment.

### DETAILED DESCRIPTION OF EMBODIMENTSN

Hereinafter, an embodiment of the present invention will be described with reference to the drawings.

### <Overview of Management System>

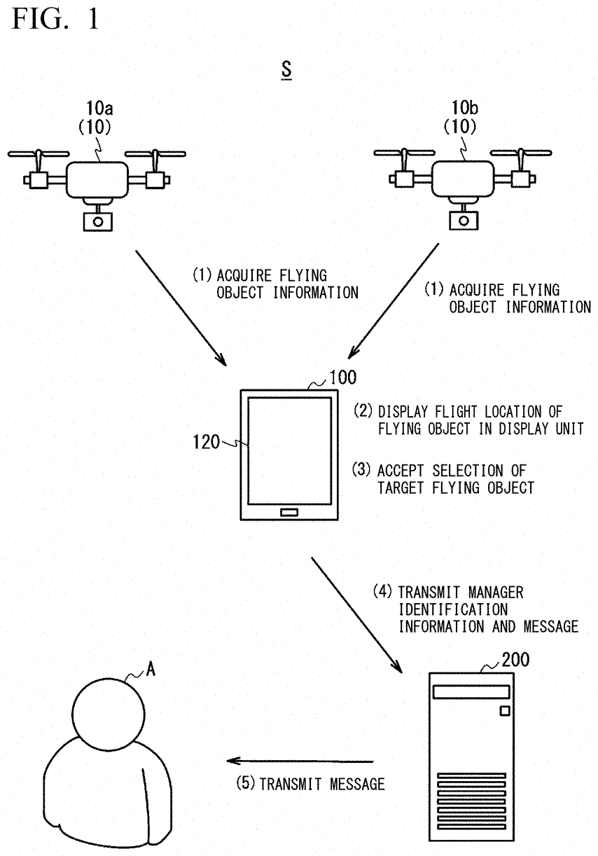

An overview of a management system according to one embodiment of the present invention will be described with reference to FIG. 1.

FIG. 1 is a schematic view illustrating a configuration of a management system S according to one embodiment of the present invention. The management system S is a system that manages flight of a plurality of flying objects 10. As illustrated in FIG. 1, the management system S includes a plurality of flying objects 10a and 10b, a communication terminal 100, and a management device 200. The flying objects 10a and 10b may also be collectively referred to as a flying object 10.

The flying object 10, for example, is an unmanned flying object such as a drone and can perform monitoring, maintenance, aerial photography, delivery, and the like. An imaging unit that images surroundings is mounted in the flying object 10. The flying object 10 flies in a predetermined flight path and performs a predetermined operation. The flying object 10a illustrated in FIG. 1 is assumed to be a flying object owned by a user of the communication terminal 100, and the flying object 10b is assumed to be a flying object managed by a manager A who is another user.

The communication terminal 100 is a terminal that is used by the user of the flying object 10a. The user can input information about a flight plan of the flying object 10a and the like to the communication terminal 100. The communication terminal 100 can communicate with the flying object 10a. The communication terminal 100 is not limited to a terminal used by the user of the flying object 10a but may be a terminal used by a monitoring staff monitoring flying objects 10 during flight instead of a manager of a specific flying object 10.

The management device 200 manages flight and the like of flying objects 10. The management device 200 can communicate with the communication terminal 100.

For example, the management device 200 generates a flight plan on the basis of information input by a user in the communication terminal 100 and gives flight permission or flight authentication for allowing the flying object 10 to fly in accordance with the generated flight plan to a user (a manager) of the flying object 10.

Meanwhile, there are cases in which a plurality of flying objects 10 come close to each other during flight and cases in which some flying objects 10 fly near a flight prohibition area. In such a case, a user or a monitoring staff of the flying objects 10 needs to contact a manager of a target flying object 10 for avoiding collision between flying objects 10 or avoiding flight in the flight prohibition area.

For easy contact with the manager of the target flying object 10, the management system S according to this embodiment performs the following processes.

First, the communication terminal 100 acquires flying object information from the flying object 10 (Process (1)). The flying object information includes manager identification information of the manager of the flying object 10 and information about a flight location of the flying object 10. For example, the communication terminal 100 acquires flying object information including manager identification information of a manager A of the flying object 10b and information about a flight location of the flying object 10b from the flying object 10b. Similarly, the communication terminal 100 also acquires flying object information from the flying object 10a.

The communication terminal 100 causes the display unit 120 to display the flight locations of the flying objects 10 of which the flying object information has been acquired (Process (2)). For example, a plurality of flying objects 10 are represented on a map in the display unit 120, and a mutual positional relation can be easily perceived.

The communication terminal 100 accepts selection of a target flying object that is performed by the user of the communication terminal 100 among the displayed flying objects 10 (Process (3)). For example, the user of the communication terminal 100 sees the display unit 120, and in a case in which it is determined that there is a likelihood of the flying object 10b coming close to his or her flying object 10a, selects the flying object 10b as a target flying object.

The communication terminal 100 transmits manager identification information of a manager of a target flying object selected by a user and a message for the manager to the management device 200 (Process (4)). For example, the communication terminal 100 transmits the manager identification information of the manager A of the flying object 10b and a message for the manager A to the management device 200. The message for the manager A, for example, is content indicating that, should the flying object 10b continue to fly, there is a likelihood of the flying object 10b approaching the flying object 10a.

The management device 200 transmits the message received from the communication terminal 100 to a manager of a target flying object (Process (5)). For example, the management device 200 identifies the manager A from the manager identification information received from the communication terminal 100 and transmits the message to a terminal and the like used by the identified manager A.

Although the communication terminal 100 is configured to transmit the message for a manager of a target flying object to the management device 200 in the description presented above, the configuration is not limited thereto. For example, the communication terminal 100 may transmit a chat start request for chatting with the manager of the target flying object to the management device 200. In such a case, a user of the communication terminal 100 can contact a manager through a text or voice chat application.

### <Configuration of Communication Terminal>

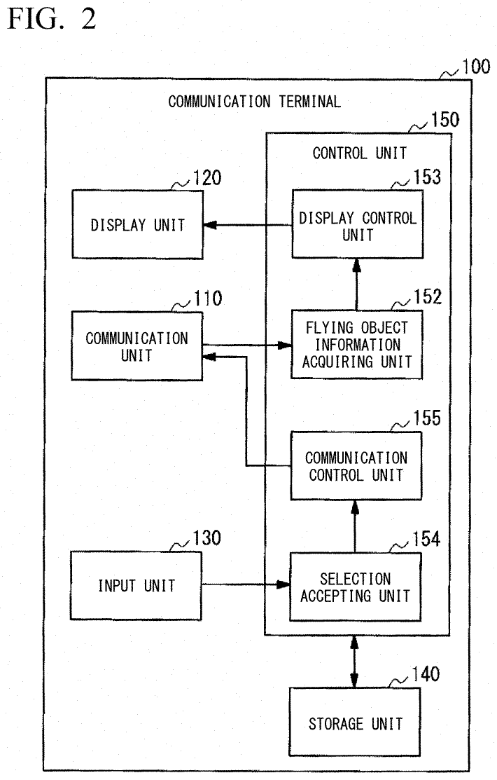

A configuration of the communication terminal 100 will be described with reference to FIG. 2.

FIG. 2 is a block diagram illustrating the configuration of the communication terminal 100. As illustrated in FIG. 2, the communication terminal 100 includes a communication unit 110, a display unit 120, an input unit 130, a storage unit 140, and a control unit 150.

The communication unit 110 is a communication interface used for the communication terminal 100 to transmit/receive information to/from the flying object 10 and the management device 200. For example, the communication unit 110 receives flying object information from the flying object 10. The flying object information includes manager identification information representing a manager of the flying object 10 and information about a flight location of the flying object 10. In addition, the communication unit 110 transmits the information input to the communication terminal 100 by the user and the like to the management device 200.

The communication unit 110 directly receives flying object information from the flying object 10. For example, the communication unit 110 directly receives flying object information from the flying object 10 using Bluetooth Low Energy (BLE) that is a short-range radio communication technology. However, the configuration is not limited thereto, and the communication unit 110 may receive flying object information from the flying object 10 through a mobile communication network. In addition, the communication unit 110 may directly receive flying object information from a flying object 10 located near the communication terminal 100 and receive flying object information from a flying object 10 located far through a mobile communication network. In other words, the communication unit 110 receives flying object information by switching to an appropriate communication scheme for each flying object 10.

The display unit 120 is an interface used for visually notifying the manager of the communication terminal 100 and the like of various kinds of information. For example, the display unit 120 displays a flight location of the flying object 10 of which flying object information has been received. In accordance with this, a user of the communication terminal 100 can easily perceive locations of his or her flying object 10 and nearby flying objects 10.

The input unit 130 is a device that is used for a user of the communication terminal 100 to perform an input operation and the like. For example, a user performs an operation of selecting one flying object among flying objects 10 displayed in the display unit 120 through the input unit 130. In addition, the user performs an operation of inputting a message and the like on an input screen displayed in the display unit 120.

The storage unit 140 is a storage medium including a read only memory (ROM), a random access memory (RAM), and the like. The storage unit 140 stores a program that is executed by the control unit 150. For example, the storage unit 140 stores flying object information received by the communication unit 110 for each flying object 10.

The control unit 150, for example, is a central processing unit (CPU). By executing programs stored in the storage unit 140, the control unit 150 functions as a flying object information acquiring unit 152, a display control unit 153, a selection accepting unit 154, and a communication control unit 155.

The flying object information acquiring unit 152 acquires flying object information including manager identification information of a manager of a flying object 10 and information about a flight location from the flying object 10. In other words, the flying object information acquiring unit 152 acquires flying object information that is received from the flying object 10 by the communication unit 110. For example, the flying object information acquiring unit 152 acquires flying object information of flying objects 10 from the flying objects 10 located within the range of a predetermined distance from a flying object 10 managed by the user of the communication terminal 100.

The flying object information acquiring unit 152 may acquire flying object information of a managed flying object that is managed by a user of its own terminal among flying objects 10. Here, the managed flying object is the flying object 10a illustrated in FIG. 1, and the flying object information acquiring unit 152 also acquires flying object information from the flying object 10a.

The manager identification information included in the flying object information is identification information used for identifying a manager of the flying object 10. For example, the flying object information acquiring unit 152 acquires identification information (for example, a manager ID) used for identifying the manager A of the flying object 10b illustrated in FIG. 1. The identification information of managers is set in advance, for example, by the management device 200 or the like.

The information about a flight location included in the flying object information may include path information representing a flight path of the flying object 10. In other words, the flying object information acquiring unit 152 acquires path information that represents a path on which the flying object 10 has actually flied until then. For example, the flying object information acquiring unit 152 acquires a flight path of a flying object 10 by connecting flight locations included in the flying object information received from the flying object 10 at predetermined intervals.

In addition, the information about a flight location may include scheduled flight information that represents a scheduled flight location or a scheduled flight path of the flying object 10. In other words, the flying object information acquiring unit 152 acquires information of a scheduled path in the event of the flying object 10 continuing to fly. For example, the scheduled flight location and the scheduled flight path are identified by receiving a flight plan of the flying object 10 that is generated by the management device 300.

The display control unit 153 controls display of the display unit 120. In this embodiment, the display control unit 153 causes the display unit 120 to display a flight location of the flying object 10 on the basis of the flying object information acquired by the flying object information acquiring unit 152. More specifically, the display control unit 153 displays the location of the flying object 10 on a display screen of the display unit 120 on the basis of the information about the flight location included in the flying object information.

The display control unit 153 causes the display unit 120 to display a flight location of a managed flying object on the basis of the flying object information of the managed flying object (more specifically, the flying object 10a illustrated in FIG. 1) managed by the user of the communication terminal 100. In other words, the display control unit 153 causes the display unit 120 to display a flight location of the managed flying object on the basis of the flying object information of the managed flying object acquired by the flying object information acquiring unit 152.

The display control unit 153 may cause the display unit 120 to simultaneously display flight locations of the managed flying object and other flying objects 10. For example, the display control unit 153 displays all of the managed flying object and nearby flying objects 10 on one display screen. In accordance with this, the user of the communication terminal 100 can perceive locations of all of the managed flying object and the other flying objects 10.

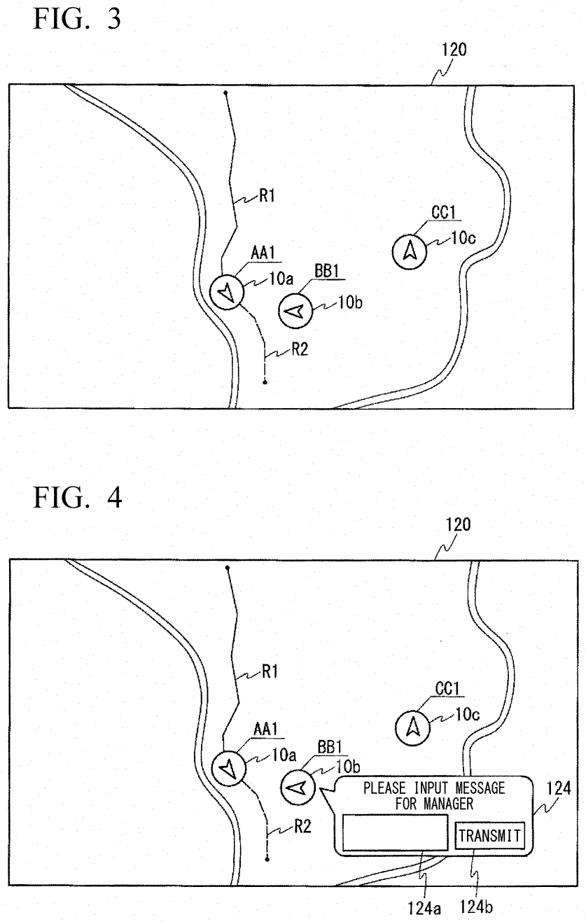

FIG. 3 is a schematic diagram illustrating a display example of the display unit 120. Here, icons representing three flying objects 10a, 10b, and 10c are displayed on a map. These icons are formed as diagrams that can be selected by a user. A flying object 10a is a flying object managed by a user of the communication terminal 100, and flying objects 10b and 10c are flying objects managed by other managers. The display control unit 153 illustrates directions using arrows such that flight directions of the flying objects 10a, 10b, and 10c can be checked. The display control unit 153 may display identification symbols AA1, BB1, and CC1 respectively used for identifying the flying objects 10a, 10b, and 10c. In addition, the display control unit 153 may display altitudes and flights speeds of the flying objects 10a, 10b, and 10c together with the identification symbols AA1, BB1, and CC1. By seeing the display illustrated in FIG. 3, the user of the communication terminal 100 can perceive that there is a likelihood of his or her flying object 10a and the flying object 10b managed by another manager coming close to each other.

The display control unit 153 may cause the display unit 120 to display a flight path represented by the path information acquired by the flying object information acquiring unit 152. For example, as illustrated in FIG. 3, the display control unit 153 displays a flight path R1 (a path denoted by a solid line) of the flying object 10a. Although only the flight path R1 of the flying object 10a is illustrated in FIG. 3, the display control unit 153 may display flight paths of the flying objects 10b and 10c.

In addition, the display control unit 153 may cause the display unit 120 to display a scheduled flight location or a scheduled flight path represented by the scheduled flight information acquired by the flying object information acquiring unit 152. For example, as illustrated in FIG. 3, the display control unit 153 displays a scheduled flight path R2 (a path denoted by a broken line) of the flying object 10a. In accordance with this, the user of the communication terminal 100 can guess whether or not his or her flying object 10a comes close to another flying object when it flies on a scheduled flight path.

The selection accepting unit 154 accepts a selection operation or an input operation of the user of the communication terminal 100. In this embodiment, the selection accepting unit 154 accepts selection of a flying object 10 managed by a manager desired to be contacted by the user (hereinafter, referred to as a target flying object). The selection accepting unit 154 accepts selection of a target flying object among one or more flying objects 10 of which flight locations are displayed in the display unit 120. For example, the user selects a flying object that may come close to his or her flying object 10 as a target flying object.

The selection accepting unit 154 may accept selection of a target flying object among flying objects 10 having a predetermined flight location relation with the managed flying object. For example, when the user selects the flying object 10b located within a predetermined distance from the flying object 10a out of the flying objects 10b and 10c illustrated in FIG. 3, the selection accepting unit 154 accepts the flying object 10b as a target flying object. On the other hand, when the user selects the flying object 10c located out of a predetermined distance from the flying object 10a, the selection accepting unit 154 does not accept the flying object 10c as a target flying object. In accordance with this, transmission of a message or the like to the manager of the flying object 10c in a case in which the flying object 10c having no likelihood of a collision is selected can be suppressed.

The display control unit 153 displays an input screen for inputting a message to the manager of the selected target flying object. For example, the display control unit 153 displays an input screen such that the input screen is superimposed on a screen representing the flight location of the flying object 10.

FIG. 4 is a schematic diagram illustrating an input screen 124. Here, it is assumed that the user selects a flying object 10b as a target flying object. When the user selects the flying object 10b, the display control unit 153 displays an input screen 124 for inputting a message to a manager of the flying object 10b. The input screen 124 includes an input field 124a for inputting a message and a transmission button 124b. When the user inputs a message to the input field 124a and then presses the transmission button 124b, the message is transmitted to the management device 30.

In order to allow the user to contact a manager of the target flying object, the communication control unit 155 transmits information about the manager and the like to the management device 200. In this embodiment, the communication control unit 155 transmits manager identification information of a manager of a target flying object selected by the user and a message for the manager to the management device 200. In accordance with this, the management device 200 can identify a contact point (an address) of a manager that has been stored in advance in association with the received manager identification information and transmit a message to the manager on the basis of this address. In addition, the management device 200 also can identify a contact point (an address) of a manager included in the received manager identification information and transmit a message to the manager on the basis of this address.

The manager identification information includes information used for identifying a manager. For example, the manager identification information includes a name and a contact point of a manager. A message for a manager is a message input by a user for the manager. For example, the communication control unit 155 transmits a message input on the input screen 124 of the display unit 120 as a message for a manager to the management device 200. More specifically, the communication control unit 155 transmits a message input by a user on the input screen 124 illustrated in FIG. 4 to the management device 200.

The communication control unit 155 may transmit transmission source information including user identification information used for identifying a user of its own terminal together with the manager identification information. For example, the communication control unit 155 transmits transmission source information including user identification information used for identifying the user of the communication terminal 100. For example, the transmission source information includes information of a name and a contact point of the user.

In the description presented above, although the communication control unit 155 transmits manager identification information and a message for the manager to the management device 200, the configuration is not limited thereto. For example, the communication control unit 155 may transmit a chatting start request for chatting with a manager to the management device 200 together with the manager identification information. The management device 200 that has received the chatting start request issues a chatting room ID used for chatting between a manager identified by the received manager identification information and a user of a transmission source identified by the transmission source identification information in association with the manager identification information and the transmission source identification information and transmits the room ID to a terminal of the manager (hereinafter referred to as a manager terminal) and a terminal of the user of the transmission source (hereinafter referred to as a transmission source terminal). By receiving a message from the manager terminal or the transmission source terminal together with the corresponding room ID, the management device 200 can transmit the message to a terminal of a manager or a user of the other side associated with the room ID.

In addition, the room ID of the chatting room described above may be generated in association with manager identification information and transmission source identification information in the communication terminal 100. In such a case, the communication control unit 155 transmits the room ID and the manager identification information to the management device 200 together with a message requesting the manager for transmission. The management device 200 transmits the message and the room ID to the manager terminal on the basis of the manager identification information.

### Modified Example

In the description presented above, a case in which a user of the communication terminal 100 contacts a manager of another flying object 10 coming close to his or her flying object 10 has been described. Hereinafter, a modified example in which an owner of the communication terminal 100 is a monitoring staff monitoring flight of flying objects 10 and contacts a manager of a flying object 10 flying in a predetermined area will be described.

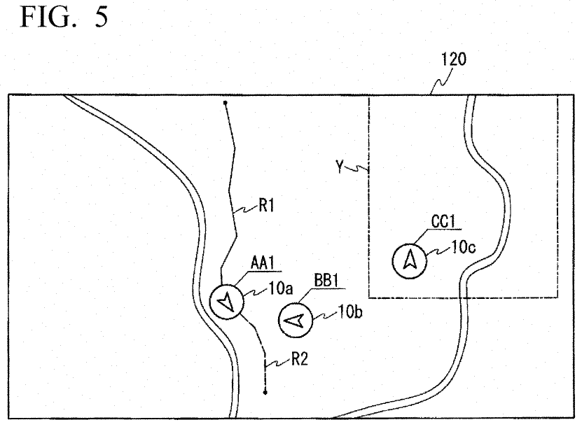

FIG. 5 is a schematic diagram illustrating the modified example and illustrates a display screen of a communication terminal 100 used by a monitoring staff. The display control unit 153 causes the display unit 120 to display flights locations of flying objects 10a, 10b, and 10c and information representing a predetermined area. For example, the display control unit 153 displays a flight prohibition area Y by enclosing it with an alternate long and short dash line as the information representing a predetermined area. Here, it is assumed that the flying object 10c is flying in the flight prohibition area Y, and the information about the flight prohibition area Y (location information of the area) has been acquired by the communication terminal 100 in advance.

The selection accepting unit 154 accepts selection of a target flying object among flying objects located in a predetermined area out of the flying objects 10a, 10b, and 10c displayed in the display unit 120. For example, when the monitoring staff selects the flying object 10c located in the flight prohibition area Y, the selection accepting unit 154 accepts the flying object 10c located in the flight prohibition area Y as a target flying object. On the other hand, even when the monitoring staff selects the flying objects 10a and 10b located outside the flight prohibition area Y, the selection accepting unit 154 does not accept the flying objects 10a and 10b as target flying objects.

The communication control unit 155 transmits manager identification information of a manager of the flying object 10c, which is a target flying object accepted by the selection accepting unit 154, and a message for the manager to the management device 200. In addition, the communication control unit 155 may transmit a chatting start request for chatting with a manager to the management device 200 instead of the message. In accordance with this, by contacting the manager of the flying object 10c illustrated in FIG. 5, the flying object 10c can be avoided from flying in the flight prohibition area.

### <Configuration of Management Device>

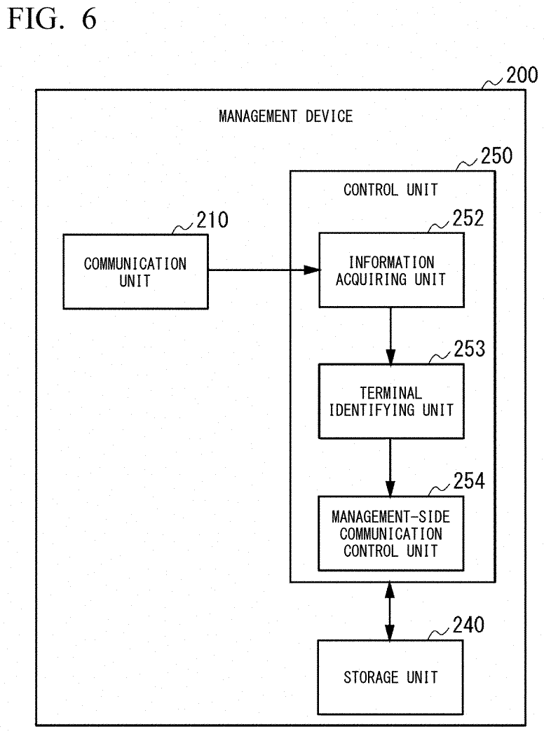

A configuration of the management device 200 will be described with reference to FIG. 6.

FIG. 6 is a block diagram illustrating the configuration of the management device 200. As illustrated in FIG. 6, the management device 200 includes a communication unit 210, a storage unit 240, and a control unit 250.

The communication unit 210 transmits/receives information to/from flying objects 10 and the communication terminal 100. For example, the communication unit 210 receives manager identification information of a manager of a target flying object transmitted by the communication terminal 100, a message for the manager, and the like. In addition, the communication unit 210 can transmit information to a terminal used by the manager of the target flying object.

The storage unit 240 is a storage medium including a Read Only Memory (ROM), a Random Access Memory (RAM), and the like. The storage unit 240 stores a program that is executed by the control unit 250. For example, the storage unit 240 stores manager information in which identification information of a manager of a flying object 10 and terminal information used by the manager are associated with each other.

For example, the control unit 250 is a Central Processing Unit (CPU). By executing the program stored in the storage unit 240, the control unit 250 functions as an information acquiring unit 252, a terminal identifying unit 253, and a management-side communication control unit 254.

The information acquiring unit 252 acquires information that has been received from the communication terminal 100 by the communication unit 210. For example, the information acquiring unit 252 acquires manager identification information of the manager of the target flying object and a message for the manager that have been transmitted from the communication terminal 100. In addition, the information acquiring unit 252 acquires transmission source information of the communication terminal 100.

The information acquiring unit 252 may acquire a chatting start request for chatting with the manager instead of the message for the manager. In such a case, the information acquiring unit 252 generates a room ID of a chatting room in which the user of the communication terminal 100 and the manager of the target flying object can participate. In a case in which the room ID has already been generated in the communication terminal 100, the information acquiring unit 252 does not need to generate the room ID.

The terminal identifying unit 253 identifies a terminal of the manager on the basis of the manager identification information received from the communication terminal 100. For example, the terminal identifying unit 253 identifies a terminal of the manager by referring to the received manager identification information and the manager information stored in the storage unit 240.

The management-side communication control unit 254 transmits a message received from the communication terminal 100 to the identified terminal. For example, the management-side communication control unit 254 transmits a message input to the input screen 124 illustrated in FIG. 4 to the terminal of the manager of the flying object 10b through the communication unit 210. The management-side communication control unit 254 may transmit identification information of a chatting room (for example, a room ID) used for chatting with the user of the communication terminal instead of the message.

### <Example of Process Performed by Communication Terminal>

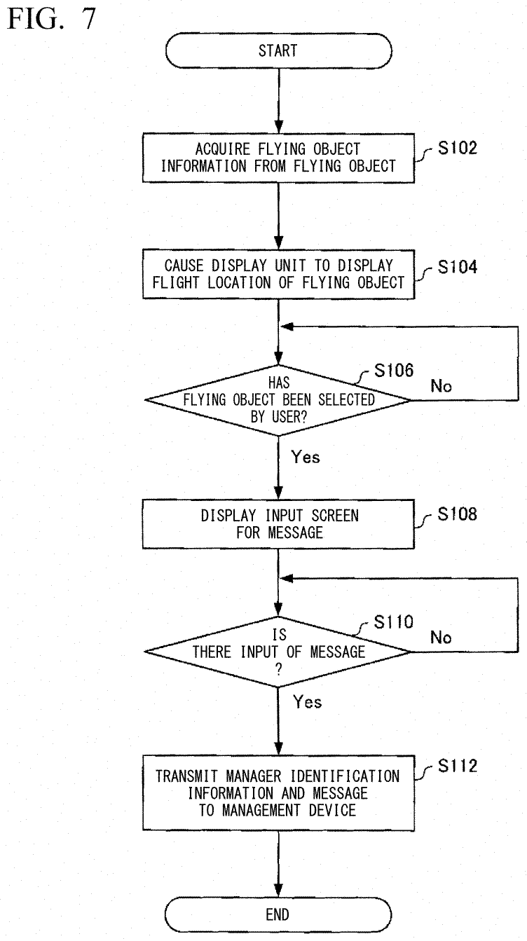

FIG. 7 is a flowchart illustrating one example of a process performed by the communication terminal 100 for contacting a manager of a target flying object. This process starts from flight of a flying object 10 managed by a user of the communication terminal 100.

First, the flying object information acquiring unit 152 acquires flying object information including manager identification information of the manager of the flying object 10 and location information about a flight location from the flying object 10 (Step S102). For example, the flying object information acquiring unit 152 acquires flying object information from flying objects 10 flying within a predetermined distance from the flying object 10 managed by the user.

Next, the display control unit 153 causes the display unit 120 to display flight locations of the flying objects 10 on the basis of the acquired flying object information (Step S104). For example, the display control unit 153 causes the display unit 120 to display a flying object 10 managed by the user and nearby flying objects 10. In accordance with this, the user can perceive positional relations between his or her flying object 10 and other flying objects 10 by seeing the display unit 120.

When the user selects one flying object 10 among the flying objects 10 displayed in the display unit 120 (Step S106: Yes), the display control unit 153 displays an input screen 124 for messages (Step S108).

When the user inputs a message to the input screen 124 (Step S110: Yes), the communication control unit 155 transmits manager identification information of a manager of the target flying object and the input message to the management device 200 (Step S112). For example, the management device 200 that has received the manager identification information and the message transmits the message to the terminal of the manager of the target flying object and the like.

<Effects of this Embodiment>

When a target flying object is selected from among flying objects 10 of which flight locations are displayed in the display unit 120, the communication terminal 100 according to this embodiment described above transmits manager identification information of a manager of the target flying object and a message for the manager or a chatting start request for chatting with the manager to the management device 200.

In accordance with this, the management device 200 transmits a message to the manager of the target flying object or allows the user of the communication terminal 100 and the manager to chat with each other, whereby the user of the communication terminal 100 can easily contact the manager of the target flying object.

In addition, according to the present invention, a contribution to Goal 9 “Amend Infrastructure of Industry and Technology Innovation” of Sustainable Development Goals (SDGs) led by the U.N. can be made.

As above, although the embodiment of the present invention has been described, the technical scope of the present invention is not limited to the descriptions of the embodiment described above, and various alternations and changes can be made within the range of the concept thereof. For example, all or some of the devices may be configured by being functionally or physically distributed/integrated in arbitrary units. In addition, a new embodiment generated in accordance with an arbitrary combination of a plurality of embodiments also belongs to an embodiment of the present invention. Effects of the new embodiment generated in accordance with a combination also have the effects of the original embodiments.

What is claimed is:

1. A communication terminal comprising:
a flying object information acquiring unit configured to acquire flying object information including manager identification information of managers of flying objects and information about flight locations from the flying objects;
a display control unit configured to cause a display unit to display the flight locations of the flying objects on the basis of the acquired flying object information;
a selection accepting unit configured to accept selection of a target flying object from among one or more flying objects of which the flight locations are displayed in the display unit; and
a communication control unit configured to transmit the manager identification information of the manager of the selected target flying object and a message for the manager or a chat start request for chatting with the manager to a management device.

2. The communication terminal according to claim 1,
wherein the display control unit displays an input screen for inputting a message for the manager of the selected target flying object, and
wherein the communication control unit transmits the manager identification information of the manager of the target flying object and a message input to the input screen to the management device.

3. The communication terminal according to claim 1,
wherein the information about the flight locations includes path information representing flight paths of the flying objects, and
wherein the display control unit causes the display unit to display the flight paths represented by the acquired path information.

4. The communication terminal according to claim 1,
wherein the information about the flight locations includes scheduled flight information representing scheduled flight locations or scheduled flight paths of the flying objects, and
wherein the display control unit causes the display unit to display the scheduled flight locations or the scheduled flight paths represented by the acquired scheduled flight information.

5. The communication terminal according to claim 1, wherein the communication control unit transmits transmission source information including user identification information used for identifying a user of its own terminal together with the manager identification information.

6. The communication terminal according to claim 1, wherein the flying object information acquiring unit receives the flying object information directly from the flying objects or receives the flying object information from the flying objects through a mobile communication network.

7. The communication terminal according to claim 1,
wherein the flying object information acquiring unit acquires the flying object information of a managed flying object managed by a user of its own terminal among the flying objects, and
wherein the display control unit causes the display unit to display a flight location of the managed flying object on the basis of the acquired flying object information of the managed flying object.

8. The communication terminal according to claim 7,
wherein the display control unit causes the display unit to simultaneously display flight locations of the managed flying object and other flying objects, and
wherein the selection accepting unit accepts selection of the target flying object among flying objects having a predetermined flight location relation with the managed flying object out of the other flying objects.

9. The communication terminal according to claim 1,
wherein the display control unit causes the display unit to display the flight locations of the flying objects and information representing a predetermined area, and
wherein the selection accepting unit accepts selection of the target flying object among flying objects located in the predetermined area out of the flying objects.

10. A management system comprising:
a management device of flying objects; and
a communication terminal configured to communicate with the management device,
wherein the communication terminal includes:
a flying object information acquiring unit configured to acquire flying object information including manager identification information of managers of flying objects and information about flight locations from the flying objects;
a display control unit configured to cause a display unit to display the flight locations of the flying objects on the basis of the acquired flying object information;
a selection accepting unit configured to accept selection of a target flying object from among one or more flying objects of which the flight locations are displayed in the display unit; and
a communication control unit configured to transmit the manager identification information of the manager of the selected target flying object, transmission source information including user identification information used for identifying a user of its own terminal, and a message for the manager or a chat start request for chatting with the manager to a management device, and
wherein the management device includes:
a terminal identifying unit configured to identify a terminal of the manager on the basis of the manager identification information received from the communication terminal; and
a management-side communication control unit configured to transmit the message received from the communication terminal or identification information of a chat room used for chatting with the user of the communication terminal to the identified terminal.

11. A communication control method causing a computer to perform:
acquiring flying object information including manager identification information of managers of flying objects and information about flight locations from the flying objects;
causing a display unit to display the flight locations of the flying objects on the basis of the acquired flying object information;
accepting selection of a target flying object from among one or more flying objects of which the flight locations are displayed in the display unit; and
transmitting the manager identification information of the manager of the selected target flying object and a message for the manager or a chat start request for chatting with the manager to a management device.
